(19) United States
(12) Patent Application Publication
(10) Pub. No.: US 2018/0194081 A1
(43) Pub. Date: Jul. 12, 2018

(54) MAT AND METHOD TO MANUFACTURE MAT

(71) Applicant: Chun-Fu KUO, Taichung (TW)

(72) Inventor: Chun-Fu KUO, Taichung (TW)

(21) Appl. No.: 15/404,695

(22) Filed: Jan. 12, 2017

(51) Int. Cl. B29C 69/00

(52) U.S. Cl. CPC B29C 69/001

(57) ABSTRACT

The mat of the present invention includes a main body integrally formed by a plastic material. The main body at least has a first surface and a second surface adjacent to the first face. The first face and the second face have different surface physical characteristics. The first surface and the second surface are shaped into a third surface and a fourth surface respectively. The third surface and the fourth surface have a substantially same surface physical characteristic. An angle between the third surface and the fourth surface outside the main body is a specific value.

### BACKGROUND OF THE INVENTION

### Field of the Invention

The present invention relates to a mat and a method to manufacture a mat.

### Description of the Prior Art

Generally, mats made of rubber are manufactured by placing rubber material in a mold to shape. To manufacture mats in various sizes and shapes, molds having various sizes and shapes have to be prepared. Thus, the cost is high. Especially, the cost is increased when the mats are manufactured in a small amount.

Besides, to manufacture a mat having a slight difference in angle, different molds have to be prepared. Thus, cost of stock is hardly reduced.

### SUMMARY OF THE INVENTION

The main object of the present invention is to provide a mat which is easy to be manufactured in various sizes.

To achieve the above and other objects, a mat of the present invention includes a main body integrally formed by a plastic material. The main body at least has a first surface and a second surface adjacent to the first face. The first face and the second face have different surface physical characteristics. The first surface and the second surface are shaped into a third surface and a fourth surface respectively. The third surface and the fourth surface have a substantially same surface physical characteristic. An angle between the third surface and the fourth surface outside the main body is a specific value.

To achieve the above and other objects, a method to manufacture mat of the present invention includes the following steps.

Shaping: shaping a main body with a plastic material with a mold. The main body at least has a first surface.

Cutting: cutting out a part of the main body to form a second surface. A surface physical characteristic of the second surface is different from that of the first surface. The second surface is adjacent to the first surface.

Shaping again: the first surface and the second surface under surface processing so that a third surface and a fourth surface are formed from the first surface and the second surface respectively wherein the third surface and the fourth surface have substantially same surface physical characteristics. An angle between the third surface and the fourth surface outside the main body is a specific value.

Thereby, the mat can be manufactured into various sizes and shapes without preparing various molds.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a mat of the present invention during a step of shaping.

FIG. 1a is a stereogram of a mat of the present invention during a step of cutting.

FIG. 1b is a stereogram of a mat of the present invention during a step of shaping again.

FIG. 2 is a partial cross-section of a mat of the present invention during a step of shaping.

FIG. 2a is a partial cross-section of a mat of the present invention during a step of cutting.

FIG. 2b is a partial cross-section of a mat of the present invention during a step of shaping again.

### DETAILED DESCRIPTION OF THE PREFERRED EMBODIMENTS

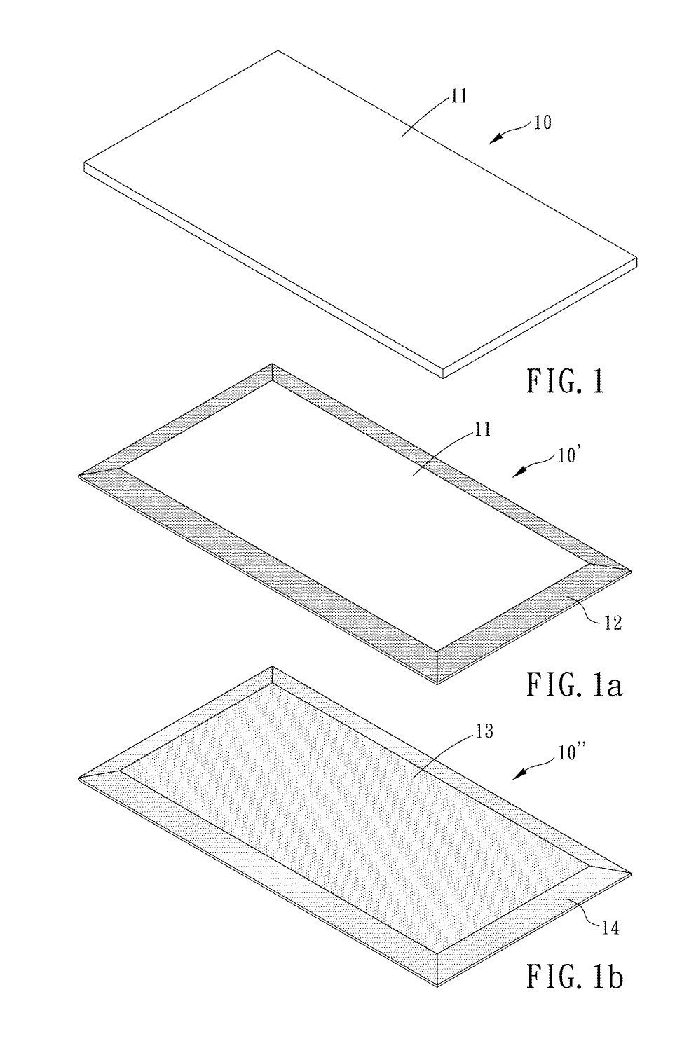

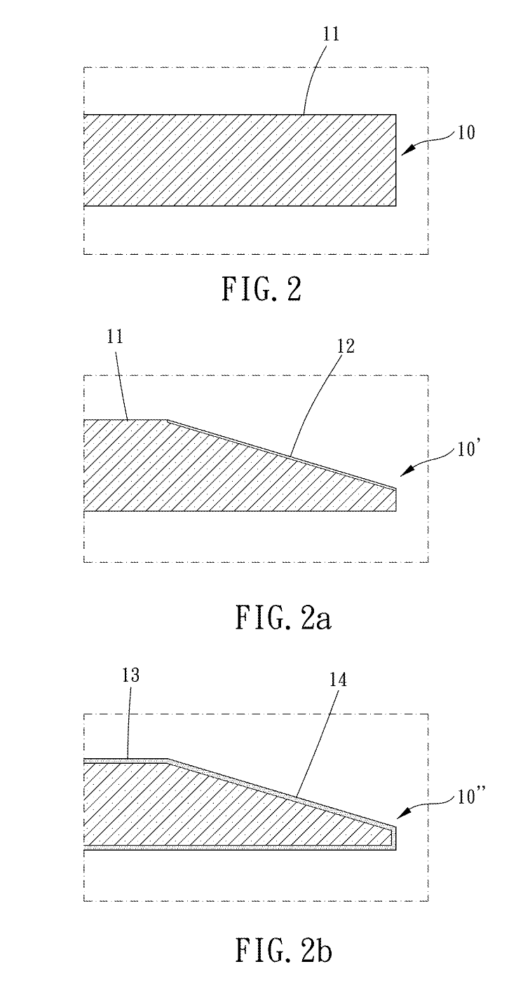

Please refer to FIGS. 1 to 2b, the mat of the present invention includes a main body 10 integrally formed by a plastic material, such as rubber or rubber composite to be soft and resilient. The main body 10 at least has a first surface 11 and a second surface 12 adjacent to the first surface 11. The first surface 11 has a surface physical characteristic, such as roughness, different from that of the second surface 12. The first surface 11 and the second surface 12 are shaped into a third surface 13 and a fourth surface 14 respectively wherein the third surface 13 and the fourth surface 14 have a substantially same surface physical characteristic, such as roughness. That is, the surface physical characteristics of the third surface 13 and the fourth surface 14 can have extremely slight differences to be ignorable. An angle between the third surface 13 and the fourth surface 14 outside the main body 10 is preferably larger than 180 degrees but not larger than 270 degrees so that the fourth surface 14 is an inclined face with respect to the third surface 13.

In the present embodiment, the mat is cuboid and having a top face and a bottom face. Four lateral faces connect the top face and the bottom face therebetween. The first surface 11 is located on the top face, and the second surface 12 is located on each of the lateral faces. Preferably, a plurality of bumps formed integrally on the main body 10 are distributed over the third surface 13 and the fourth surface 14. For example, the bumps can be formed by a mold whose inner surface having a plurality of holes.

The present invention also provides a method to manufacture mat including the following steps.

Shaping: shaping a main body 10 from a plastic material by a mold. The main body 10 at least has a first surface 11. In the present embodiment, the plastic material is rubber or rubber composite to be soft and resilient.

Cutting: cutting out a part of the main body 10 to form a second surface 12 having a surface physical characteristic different from that of the first surface 11, such as roughness. The second surface 12 is adjacent to the first surface 11. In the present embodiment, the mat is cuboid and having a top face and a bottom face. Four lateral faces connect the top face and the bottom face therebetween. The first surface 11 is located on the top face, and the second surface 12 is located on each of the lateral faces.

Shaping again: the first surface 11 and the second surface 12 under surface processing so that a third surface 13 and a fourth surface 14 are formed from the first surface and the second surface respectively wherein the third surface 13 and the fourth surface 14 have substantially same surface physical characteristics. An angle between the third surface 13 and the fourth surface 14 outside the main body 10″is preferably larger than 180 degrees but not larger than 270 degrees. Preferably, the first surface 11 and the second surface 12 are heated and compressed to form the third surface 13 and the fourth surface 14.

Specifically, during the step of shaping, the plastic material is cross-bridged incompletely. However, during the step of shaping again, the plastic material is cross-bridged fully to form the third surface 13 and the fourth surface 14. Besides, a plurality of bumps are integrally formed on the third surface 13 and the fourth surface 14 to make the surface physical characteristics of the third surface 13 and the fourth surface 14 more similar to each other. For example, the bumps are formed by a mold whose inner surface having a plurality of holes.

In conclusion, the step of cutting is advantageous that the size or shape of the mat can be modified. Thus, the main body can be manufactured to mats in various sizes and shapes so that it is not necessary to prepare molds in various sizes and shapes. Therefore, the cost can be reduced, and the mat can be manufactured in a small amount. That is, the cost of stock can be reduced.

What is claimed is:

1. A mat, including a main body integrally formed by a plastic material, the main body at least having a first surface and a second surface adjacent to the first face, the first face and the second face having different surface physical characteristics, the first surface and the second surface being shaped into a third surface and a fourth surface respectively, the third surface and the fourth surface having a substantially same surface physical characteristic, an angle between the third surface and the fourth surface outside the main body being a specific value.

2. The mat of claim 1, wherein the angle between the third surface and the fourth surface outside the main body is larger than 180 degrees but not larger than 270 degrees.

3. The mat of claim 2, being cuboid and having a top face and a bottom face, four lateral faces connecting the top face and the bottom face therebetween, the first surface being located on the top face, the second surface being located on each of the lateral faces.

4. The mat of claim 1, wherein the plastic material is selected from a group composed of rubber and rubber composite, the plastic material is soft and resilient.

5. The mat of claim 1, wherein a plurality of bumps formed integrally on the main body are distributed over the third surface and the fourth surface.

6. The mat of claim 1, wherein a roughness of the first surface is different from that of the second surface.

7. A method to manufacture mat, including:
shaping: shaping a main body with a plastic material with a mold, the main body at least having a first surface;
cutting: cutting out a part of the main body to form a second surface, a surface physical characteristic of the second surface being different from that of the first surface, the second surface being adjacent to the first surface;
shaping again: the first surface and the second surface under surface processing so that a third surface and a fourth surface are formed from the first surface and the second surface respectively wherein the third surface and the fourth surface have substantially same surface physical characteristics, an angle between the third surface and the fourth surface outside the main body being a specific value.

8. The method to manufacture mat of claim 7, wherein the angle between the third surface and the fourth surface outside the main body is larger than 180 degrees but not larger than 270 degrees.

9. The method to manufacture mat of claim 8, wherein the mat being cuboid and having a top face and a bottom face, four lateral faces connecting the top face and the bottom face therebetween, the first surface being located on the top face, the second surface being located on each of the lateral faces.

10. The method to manufacture mat of claim 7, wherein the plastic material is selected from a group composed of rubber and rubber composite, the plastic material is soft and resilient.

11. The method to manufacture mat of claim 7, wherein the plastic material is cross-bridged incompletely during the step of shaping, the plastic material is cross-bridged fully during the step of shaping again.

12. The method to manufacture mat of claim 7, wherein during the step of shaping again, the first surface and the second surface are heated and compressed to form the third surface and the fourth surface.

13. The method to manufacture mat of claim 7, wherein a plurality of bumps formed integrally on the main body are distributed over the third surface and the fourth surface.

14. The method to manufacture mat of claim 7, wherein a roughness of the first surface is different from that of the second surface.

15. A mat, made by the method to manufacture mat of claim 7
